(19) United States
(12) Patent Application Publication
(10) Pub. No.: US 2025/0392957 A1
(43) Pub. Date: Dec. 25, 2025

(54) AUDIO TRANSMISSION METHOD AND SYSTEM

(71) Applicant: Samsung Electronics Co., Ltd., Suwon-si (KR)

(72) Inventors: Seungbeom SEO, Suwon-si (KR); Kisoo AN, Suwon-si (KR)

(21) Appl. No.: 19/241,978

(22) Filed: Jun. 18, 2025

(30) Foreign Application Priority Data
Jun. 21, 2024 (KR) 10-2024-0081375

(51) Int. Cl. H04W 28/06; H04W 4/80; H04W 28/02

(52) U.S. Cl. CPC H04W 28/065; H04W 28/0252; H04W 4/80

(57) ABSTRACT

A method performed by an electronic device is provided. The method includes receiving, by the electronic device, an advertising packet including a relay status of a source device, transmitting, by the electronic device to the source device, a response for initiating a relay, based on a first user input for triggering a relay, transmitting, by the electronic device to the source device, relay capability information including an available maximum data rate and an identifier of each of one or more sink devices paired with the electronic device, negotiating, by the electronic device, with the source device on at least one parameter for a relay, receiving, by the electronic device, an audio frame from the source device by using a first wireless communication technology, based on the at least one parameter agreed with the source device, and transmitting, by the electronic device, the audio frame to a target sink device by using a second wireless communication technology, based on the at least one parameter agreed with the source device.

### CROSS-REFERENCE TO RELATED APPLICATION(S)

This application is based on and claims priority under 35 U.S.C. § 119 (a) of a Korean patent application number 10-2024-0081375, filed on Jun. 21, 2024, in the Korean Intellectual Property Office, the disclosure of which is incorporated by reference herein in its entirety.

### BACKGROUND

### 1. Field

The disclosure relates to an audio transmission method and system.

### 2. Description of Related Art

With the commercial success of wireless earphones, the demand for lossless audio services through wireless communication has increased. The lossless audio may refer to an audio compressed by using a lossless compression format (e.g., Free Lossless Audio Codec (FLAC)) and may be characterized by having a larger amount of data than an audio compressed by using a lossy compression format (e.g., MP3).

Most wireless earphones support Bluetooth to receive audios from mobile devices (e.g., smartphones or tablets). Bluetooth has been adopted for wireless earphones due to its low power consumption and high compatibility with various devices. However, because Bluetooth has a relatively low data rate, Bluetooth may be unsuitable for a lossless audio service that requires a large amount of data to be transmitted with low latency. Accordingly, various methods have been attempted to increase the data rate of Bluetooth.

Moreover, with the popularization of televisions (TVs) supporting wireless communication, the number of users listening to TV sounds through wireless earphones has increased, and the demand for lossless audio services through TVs has also increased. However, in most TV viewing environments, because the distance between a wireless earphone and a TV is long, even when the maximum data rate of Bluetooth is sufficiently high, the link condition between the TV and the wireless earphone may be poor and thus the lossless audio service may be restricted.

Even when wireless earphones with high-speed Bluetooth suitable for exchanging lossless audios are launched, because the existing products (e.g., TVs) still only support low-speed Bluetooth, it may still be difficult to provide a lossless audio service by using only Bluetooth.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an audio transmission and method.

Additional aspects will be set forth in part in the description which follows and, in part, will be apparent from the description, or may be learned by practice of the presented embodiments.

In accordance with an aspect of the disclosure, a method performed by an electronic device is provided. The method includes receiving, by the electronic device, an advertising packet including a relay status of a source device, transmitting, by the electronic device to the source device, a response for initiating a relay, based on a first user input for triggering a relay, transmitting, by the electronic device to the source device, relay capability information including an available maximum data rate and an identifier of each of one or more sink devices paired with the electronic device, negotiating, by the electronic device, with the source device on at least one parameter for a relay, receiving, by the electronic device, an audio frame from the source device by using a first wireless communication technology, based on the at least one parameter agreed with the source device, and transmitting, by the electronic device, the audio frame to a target sink device by using a second wireless communication technology, based on the at least one parameter agreed with the source device.

In accordance with another aspect of the disclosure, an electronic device is provided. The electronic device includes first communication circuitry configured to transmit/receive signals to/from an external device by using a first wireless communication technology, second communication circuitry configured to transmit/receive signals to/from the external device by using a second wireless communication technology, memory, comprising one or more storage media, storing one or more instructions, and at least one processor communicatively coupled to the first communication circuitry, the second communication circuitry and the memory, wherein the one or more instructions, when executed by the at least one processor individually or collectively, cause the electronic device to receive an advertising packet including a relay status of a source device, transmit, to the source device, a response for initiating a relay, based on a first user input for triggering a relay, transmit, to the source device, relay capability information including an available maximum data rate and an identifier of each of one or more sink devices paired with the electronic device, negotiate with the source device on at least one parameter for a relay, receive an audio frame from the source device by using the first wireless communication technology, based on the at least one parameter agreed with the source device, and transmit the audio frame to a target sink device by using the second wireless communication technology, based on the at least one parameter agreed with the source device.

In accordance with another aspect of the disclosure, a method performed by an electronic device is provided. The method includes broadcasting, by the electronic device, an advertising packet including a relay status of the electronic device, receiving, by the electronic device from a relay device, a response for initiating a relay, receiving, by the electronic device from the relay device, relay capability information including an available maximum data rate and an identifier of each of one or more sink devices paired with the relay device, negotiating, by the electronic device, with the relay device on at least one parameter for a relay, and transmitting, by the electronic device, an audio frame to the relay device by using a first wireless communication technology, based on the at least one parameter agreed with the relay device.

In accordance with another aspect of the disclosure, an electronic device is provided. The electronic device includes first communication circuitry configured to transmit/receive signals to/from an external device by using a first wireless communication technology, second communication circuitry configured to transmit/receive signals to/from the external device by using a third wireless communication technology, memory, comprising one or more storage media, storing one or more instructions, and at least one processor communicatively coupled to the first communication circuitry, the second communication circuitry and the memory, wherein the one or more instructions, when executed by the at least one processor individually or collectively, cause the electronic device to broadcast an advertising packet including a relay status of the electronic device, receive, from a relay device, a response for initiating a relay, receive, from the relay device, relay capability information including an available maximum data rate and an identifier of each of one or more sink devices paired with the relay device, negotiate with the relay device on at least one parameter for a relay, and transmit an audio frame to the relay device by using the first wireless communication technology, based on the at least one parameter agreed with the relay device.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include receiving, by the electronic device, an advertising packet including a relay status of a source device, transmitting, by the electronic device to the source device, a response for initiating a relay, based on a first user input for triggering a relay, transmitting, by the electronic device to the source device, relay capability information including an available maximum data rate and an identifier of each of one or more sink devices paired with the electronic device, negotiating, by the electronic device, with the source device on at least one parameter for a relay, receiving, by the electronic device, an audio frame from the source device by using a first wireless communication technology, based on the at least one parameter agreed with the source device, and transmitting, by the electronic device, the audio frame to a target sink device by using a second wireless communication technology, based on the at least one parameter agreed with the source device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an audio transmission system according to an embodiment of the disclosure;

FIG. 2 illustrates a configuration of a source device according to an embodiment of the disclosure;

FIG. 3 illustrates a configuration of a relay device according to an embodiment of the disclosure;

FIG. 4 illustrates a configuration of a sink device according to an embodiment of the disclosure;

FIG. 5 illustrates an example of a process in which an audio transmission system prepares an audio relay, according to an embodiment of the disclosure;

FIG. 6 illustrates an example in which a relay device receives a first user input for triggering a relay, according to an embodiment of the disclosure;

FIG. 7 illustrates an example in which a relay device receives a second user input for designating a target sink device, according to an embodiment of the disclosure;

FIG. 8 illustrates an example of a process in which an audio transmission system relays an audio, according to an embodiment of the disclosure;

FIG. 9 is a logical block diagram illustrating an example of an audio processing process in an audio transmission system according to an embodiment of the disclosure;

FIG. 10 illustrates an example of an operation scenario of an audio transmission system according to an embodiment of the disclosure;

FIG. 11 illustrates an example of an operation scenario of an audio transmission system according to an embodiment of the disclosure;

FIG. 12A illustrates an example of an operation scenario of an audio transmission system according to an embodiment of the disclosure;

FIG. 12B illustrates an example of an operation scenario of an audio transmission system according to an embodiment of the disclosure;

FIG. 13A illustrate an example of an operation scenario of an audio transmission system according to an embodiment of the disclosure;

FIG. 13B illustrates an example of an operation scenario of an audio transmission system according to an embodiment of the disclosure;

FIG. 14 illustrates an operating method of a relay device according to an embodiment of the disclosure; and

FIG. 15 illustrates an operating method of a source device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Throughout the specification, a layer may also be referred to as an entity.

Throughout the disclosure, the expression “at least one of a, b or c” indicates only a, only b, only c, both a and b, both a and c, both b and c, all of a, b, and c, or variations thereof.

Herein, unless the context clearly indicates otherwise, the singular forms “a”, “an”, and “the” may be construed as including plural forms. Thus, for example, reference to “a component surface” may also include reference to one or more of such surfaces.

Herein, although terms such as “first” and “second” may be used to describe various elements, these elements should not be limited by these terms. These terms are only used to distinguish one element from another element. For example, without departing from the scope of the disclosure, a first element may be referred to as a second element, and vice versa.

Herein, when an element is referred to as being “coupled” or “connected” to another element, it should be understood that the element may be directly coupled or connected to the other element or one or more other elements may be arranged therebetween. On the other hand, when an element is referred to as being “directly coupled” or “directly connected” to another element, it should be understood that there is no other element therebetween.

Herein, it will be understood that terms such as “comprise”, “include”, and “have”, when used herein, specify the presence of stated features, integers, steps, operations, elements, components, or combinations thereof, but do not preclude the presence or addition of one or more other features, integers, steps, operations, elements, components, or combinations thereof.

In describing the disclosure, descriptions of technical contents that are well known in the technical field to which the disclosure belongs and are not directly related to the disclosure will be omitted. This may be to convey the gist of the disclosure more clearly without obscuring the gist of the disclosure by omitting unnecessary descriptions. Also, terms described below may be terms defined considering functions in the disclosure and may vary according to users' or operators' intentions or practices. Therefore, definitions thereof should be made based on the contents throughout the disclosure.

For the same reason, some elements in the accompanying drawings may be exaggerated, omitted, or schematically illustrated. Also, the size of each element may not completely reflect the actual size thereof. The same or corresponding elements in each drawing may be given the same reference numerals.

Advantages and features of the disclosure and methods of achieving the same will be apparent from the embodiments described below in detail with reference to the accompanying drawings. However, the disclosure is not limited to the embodiments described below, and may be embodied in various modes. The described embodiments may be provided to make the description of the disclosure complete and to fully inform those of ordinary skill in the art about the scope of the disclosure. An embodiment of the disclosure may be defined by the claims. Throughout the disclosure, like reference numerals may denote like elements.

Herein, it should be understood that blocks in each flowchart and combinations of flowcharts may be performed by one or more computer programs including computer-executable instructions. The one or more computer programs may all be stored in a single memory or may be separately stored in a plurality of different memories.

In an embodiment of the disclosure, blocks of flowcharts and combinations of flowcharts may be performed by computer program instructions. The computer program instructions may be mounted on a processor of a general-purpose computer, special-purpose computer, or other programmable data processing apparatuses, and the instructions executed through a processor of a computer or other programmable data processing apparatuses may generate a means for performing the functions described in one or more flowchart blocks. The computer program instructions may also be stored in a computer-usable or computer-readable memory that may be directed to a computer or other programmable data processing apparatuses to implement a function in a particular manner, and the instructions stored in the computer-usable or computer-readable memory may also produce a manufacturing item containing an instruction means for performing the function described in one or more flowchart blocks. The computer program instructions may also be mounted on a computer or other programmable data processing apparatuses.

Also, each block of a flowchart may represent a module, a segment, or a portion of code that includes one or more executable instructions for performing one or more particular logical functions. In an embodiment of the disclosure, the functions mentioned in the blocks may occur in different order. For example, two blocks consecutively illustrated may be performed substantially simultaneously or may be performed in reverse order depending on the function.

All functions or operations described herein may be processed by a processor or a combination of processors. The processor or the combination of processors may include circuitry that performs processing, such as an application processor (AP), a communication processor (CP), a graphical processing unit (GPU), a neural processing unit (NPU), a microprocessor unit (MPU), a system-on-chip (SoC), or an integrated chip (IC).

The processor may include various processing circuits and/or multiple processors. For example, the term “processor” used herein, including in the claims, may include various processing circuits including at least one processor. One or more of the at least one processor may be configured to perform various functions described herein, individually and/or collectively in a distributed manner. As used herein, when “a processor”, “at least one processor”, and/or “one or more processors” are described as being configured to perform various functions, these terms may cover, without limitation, a situation in which a processor performs some of the functions and one or more other processors perform some others of the functions and a situation in which a single processor may perform all of the functions. Also, the at least one processor may include a combination of processors that perform various described functions in a distributed manner. The at least one processor may execute program instructions to achieve or perform various functions.

The term “ . . . unit” or “ . . . module” used in an embodiment of the disclosure may refer to a software component or a hardware component such as a field programmable gate array (FPGA) or an application specific integrated circuit (ASIC), and the “ . . . unit” or “ . . . module” may perform a particular function. Moreover, the “ . . . unit” or “ . . . module” is not limited to software or hardware. The “ . . . unit” or “ . . . module” may be configured to be in an addressable storage medium and may be configured to operate one or more processors. In an embodiment of the disclosure, the “. . . unit” or “ . . . module” may include components such as software components, object-oriented software components, class components, and task components and may include processes, functions, attributes, procedures, subroutines, segments of program code, drivers, firmware, microcode, circuits, data, databases, data structures, tables, arrays, and variables. The function provided by a particular component or a particular “ . . . unit” or “ . . . module” may be combined to reduce the number thereof or may be separated into additional components. Also, in an embodiment of the disclosure, the “ . . . unit” or “ . . . module” may include one or more processors.

The meanings of terms used herein will be described below.

Herein, a “data rate” may refer to a rate at which data (e.g., an audio frame) is transmitted. For example, the data rate may be represented in units of bits per second (bps). Terms such as “transmission rate”, “bit rate”, “throughput”, and “data transfer rate” may be used instead of “data rate”.

Herein, “high-speed Bluetooth” may refer to Bluetooth having a higher maximum data rate than “low-speed Bluetooth”. For example, Bluetooth Low Energy (BLE) having a maximum transmission rate of 2 Mbps may be referred to as low-speed Bluetooth, and BLE High Data Throughput (HDT) having a maximum transmission rate of 7.5 Mbps may be referred to as high-speed Bluetooth. “Low-speed Bluetooth” may also be referred to as legacy Bluetooth.

Herein, “high-speed Bluetooth” may not only include standards (e.g., Classic Bluetooth, Bluetooth Low Energy, and Bluetooth High Speed) defined by the Bluetooth Special Interest Group (SIG) but may also include methods obtained by modifying the standards to be used for audio transmission by being applied to mobile devices (e.g., smartphones, smartwatches, and tablets) and sink devices (e.g., wireless earphones, wireless headphones, and wireless headsets). For example, “high-speed Bluetooth” may include a method utilizing a higher band (e.g., 5 to 6 GHZ) than the 2.4 GHz band or a method utilizing 8 Phase Shift Keying (8PSK) instead of Gaussian Frequency Shift Keying (GFSK).

Hereinafter, embodiments of the disclosure will be described in detail with reference to the accompanying drawings.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

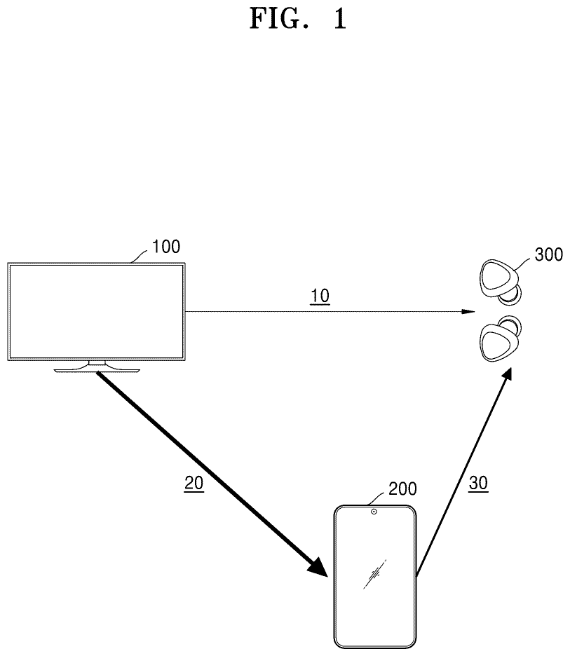

FIG. 1 illustrates an audio transmission system according to an embodiment of the disclosure.

Referring to FIG. 1, the audio transmission system may include a source device 100, a relay device 200, and a sink device 300. The audio transmission system may relate to a method of transmitting an audio from the source device 100 to the sink device 300.

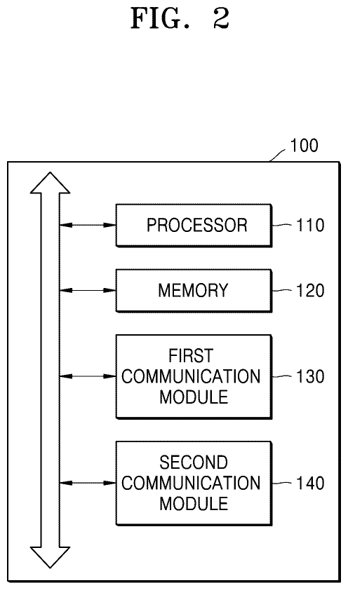

In an embodiment of the disclosure, the source device 100 may encode an audio to a quality suitable for transmission and transmit the encoded audio to the relay device 200 and/or the sink device 300. For example, the source device 100 may be, but is not limited to, a television (TV), a desktop, or a laptop. The components of the source device 100 will be described below with reference to FIG. 2.

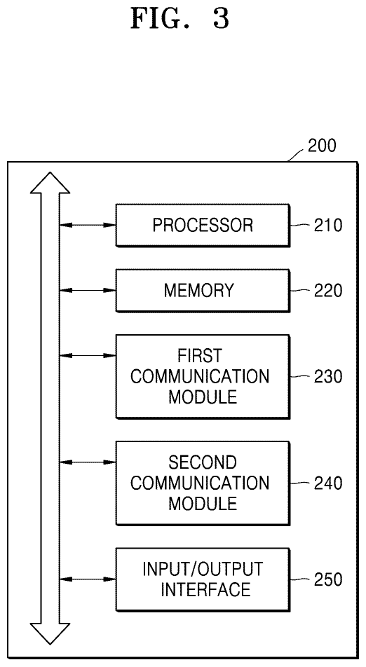

In another embodiment of the disclosure, the relay device 200 may transmit, to the sink device 300, the audio received from the source device 100. When the relay device 200 transmits an audio by using a wireless communication technology different from that used for audio reception, the relay device 200 may convert an audio into a form suitable for the wireless communication technology to be used for transmission (e.g., increasing or decreasing the size of a data packet transmitted at once or converting a data packet format from a first wireless communication technology to a second wireless communication technology). For example, the relay device 200 may be, but is not limited to, a smartphone, a tablet, a smartwatch, or a wearable device. The components of the relay device 200 will be described below with reference to FIG. 3.

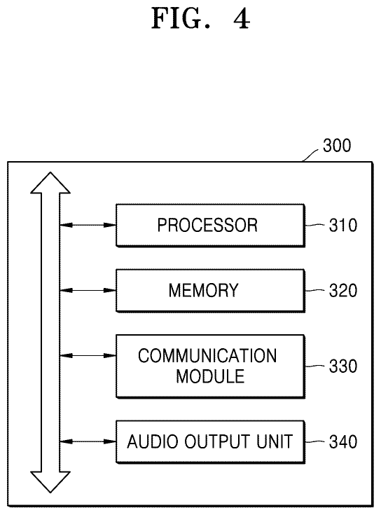

In yet another embodiment of the disclosure, the sink device 300 may receive an audio from the source device 100 and/or the relay device 200 and may play the received audio. For example, the sink device 300 may be, but is not limited to, wireless earphones, wireless earbuds, a wireless headphone, a wireless headset, a wireless speaker, or a true wireless stereo (TWS). The components of the sink device 300 will be described below with reference to FIG. 4.

In the audio transmission system, the distance between the source device 100 and the sink device 300 may be greater than the distance between the relay device 200 and the sink device 300. For example, a situation in which a user watches a TV while sitting on a sofa while wearing the sink device 300 and holding the relay device 200 in his hand may be considered.

In the audio transmission system, the source device 100 may support the first wireless communication technology and a third wireless communication technology, the relay device 200 may support the first wireless communication technology and the second wireless communication technology, and the sink device 300 may support the second wireless communication technology. In yet another embodiment of the disclosure, the first wireless communication technology may have a higher maximum data rate than the second wireless communication technology, and the second wireless communication technology may have a higher maximum data rate than the third wireless communication technology.

In yet another embodiment of the disclosure, the second wireless communication technology may be backward compatible with the third wireless communication technology. For example, the relay device 200 may communicate with the source device 100 by using the third wireless communication technology. In yet another embodiment of the disclosure, the first wireless communication technology may be Wireless Fidelity (WiFi), the second wireless communication technology may be high-speed Bluetooth, and the third wireless communication technology may be low-speed Bluetooth. However, the types of the first to third wireless communication technologies are not limited thereto.

In the example of FIG. 1, an arrow 10 may indicate that an audio is directly transmitted from the source device 100 to the sink device 300, and arrows 20 and 30 may indicate that an audio is transmitted from the source device 100 to the sink device 300 through the relay device 200. The thickness of each arrow (10, 20, 30) may correspond to a data rate. For example, the arrow 10 may correspond to the third wireless communication technology, the arrow 20 may correspond to the first wireless communication technology, and the arrow 30 may correspond to the second wireless communication technology.

In the audio transmission system, the source device 100 may directly transmit an audio to the sink device 300 by using the third wireless communication technology. However, when the distance between the source device 100 and the sink device 300 increases, the delay time may increase due to the low data rate of the third wireless communication technology and the user experience may degrade, such as an audio interruption. When the amount of audio data increases (e.g., lossless audio), this phenomenon may be further deepened.

In the audio transmission system, the source device 100 may transmit an audio to the sink device 300 through the relay device 200. For example, the source device 100 may transmit an audio to the relay device 200 by using the first wireless communication technology, and the relay device 200 may transmit the received audio to the sink device 300 by using the second wireless communication technology. Because the data rate of the first wireless communication technology is sufficiently high, even when the distance from the relay device 200 is long, the source device 100 may transmit a large amount of audio (e.g., lossless audio) without degrading the user experience. In most service environments, because the distance between the relay device 200 and the sink device 300 is relatively short, even when the relay device 200 transmits a large amount of audio to the sink device 300 by using the second wireless communication technology, the user may not feel an audio interruption.

The source device 100, the relay device 200, and the sink device 300 may perform operations for an audio relay. For example, the source device 100 may discover and connect (e.g., pairing) the relay device 200 and the sink device 300 in a wireless environment and may store information (e.g., identifiers) of the relay device 200 and the sink device 300. The source device 100 and the relay device 200 may authenticate each other for relay initiation and may negotiate on parameters for a relay (e.g., a data rate). The components of the source device 100, the relay device 200, and the sink device 300 and the operations for an audio relay will be described below in detail.

FIG. 2 illustrates a configuration of a source device 100 according to an embodiment of the disclosure.

Referring to FIG. 2, the source device 100 may include a processor 110, memory 120, a first communication module 130, and a second communication module 140. However, the components of the source device 100 are not limited thereto. For example, the source device 100 may further include a display for displaying a video.

The processor 110 may control a series of processes such that the source device 100 operates according to embodiments described below. The processor 110 may include one or more processors. The one or more processors included in the processor 110 may include circuitry such as an SoC or an IC. The one or more processors included in the processor 110 may include a general-purpose processor such as a central processing unit (CPU), an MPU, an AP, or a digital signal processor (DSP), a dedicated graphics processor such as a GPU or a vision processing unit (VPU), a dedicated artificial intelligence processor such as an NPU, or a dedicated communication processor such as a CP. When the one or more processors included in the processor 110 include a dedicated artificial intelligence processor, the dedicated artificial intelligence processor may be designed with a hardware structure specialized for processing of a particular artificial intelligence model.

The processor 110 may write data in the memory 120 and read data stored in the memory 120. The processor 110 may process data according to a predefined operation rule or an artificial intelligence model by executing a program or at least one instruction stored in the memory 120. Thus, the processor 110 may perform operations described in the following embodiments, and the operations described in the following embodiments as being performed by the source device 100 or the detailed components (e.g., 110 to 140 of FIG. 2) included in the source device 100 may be considered as being performed by the processor 110 unless otherwise described.

The memory 120 may store various programs or data. The memory 120 may include a storage medium or a combination of storage mediums such as a read-only memory (ROM), a random-access memory (RAM), a hard disk, a compact disc read-only memory (CD-ROM), and a digital versatile disc (DVD). The memory 120 may not be separately provided and may be included in the processor 110. The memory 120 may include volatile memory, nonvolatile memory, or a combination of volatile memory and nonvolatile memory. The memory 120 may store a program or at least one instruction for performing operations according to embodiments described below. The memory 120 may provide the stored data to the processor 110 at the request of the processor 110.

The first communication module 130 may exchange signals (e.g., control commands and data) with an external device by wire or wireless. The first communication module 130 may include a communication chipset that supports various communication technologies. For example, the first communication module 130 may include a short-range communicator and/or a long-range communicator. The short-range communicator may include, but is not limited to, a Bluetooth communicator, a ZigBee communicator, an infrared (Infrared Data Association (IrDA)) communicator, a WiFi Direct (WFD) communicator, an Ultra-Wideband (UWB) communicator, and/or an Ant+ communicator. The long-range communicator may include the Internet, a computer network (e.g., Local Area Network (LAN) or Wide Area Network (WAN)), and/or a mobile communicator. The mobile communicator may include, but is not limited to, a third-generation (3G) module, a fourth-generation (4G) module, a fifth-generation (5G) module, a Long Term Evolution (LTE) module, a Narrowband Internet of Things (NB-IoT) module, and/or an LTE-Machine (LTE-M) module. In an embodiment of the disclosure, the first communication module 130 may support the first wireless communication technology described above.

The second communication module 140 may exchange signals (e.g., control commands and data) with an external device by wire or wireless. The second communication module 140 may include a communication chipset that supports various communication technologies. For example, the second communication module 140 may include a short-range communicator and/or a long-range communicator. The short-range communicator may include, but is not limited to, a Bluetooth communicator, a ZigBee communicator, an infrared (IrDA) communicator, a WFD communicator, an UWB communicator, and/or an Ant+ communicator. The long-range communicator may include the Internet, a computer network (e.g., LAN or WAN), and/or a mobile communicator. The mobile communicator may include, but is not limited to, a 3G module, a 4G module, a 5G module, an LTE module, an NB-IoT module, and/or an LTE-M module. In another embodiment of the disclosure, the second communication module 140 may support the third wireless communication technology described above.

In yet another embodiment of the disclosure, the first communication module 130 may support a wireless communication technology having a higher maximum data rate than the second communication module 140. For example, the first communication module 130 may support WiFi, and the second communication module 140 may support low-speed Bluetooth.

In yet another embodiment of the disclosure, the first communication module 130 and the second communication module 140 may be implemented as one chipset capable of performing both the operation of the first communication module 130 and the operation of the second communication module 140. For example, the first communication module 130 and the second communication module 140 may be implemented as an integrated chipset that supports both WiFi and low-speed Bluetooth.

FIG. 3 illustrates a configuration of a relay device 200 according to an embodiment of the disclosure.

Referring to FIG. 3, the relay device 200 may include a processor 210, memory 220, a first communication module 230, a second communication module 240, and an input/output interface 250. However, the components of the relay device 200 are not limited thereto. For example, the relay device 200 may further include a camera for capturing an image.

The processor 210 may control a series of processes such that the relay device 200 operates according to embodiments described below. The processor 210 may include one or more processors. The one or more processors included in the processor 210 may include circuitry such as an SoC or an IC. The one or more processors included in the processor 210 may include a general-purpose processor such as a CPU, an MPU, an AP, or a DSP, a dedicated graphics processor such as a GPU or a VPU, a dedicated artificial intelligence processor such as an NPU, or a dedicated communication processor such as a CP. When the one or more processors included in the processor 210 include a dedicated artificial intelligence processor, the dedicated artificial intelligence processor may be designed with a hardware structure specialized for processing of a particular artificial intelligence model.

The processor 210 may write data in the memory 220 and read data stored in the memory 220. The processor 210 may process data according to a predefined operation rule or an artificial intelligence model by executing a program or at least one instruction stored in the memory 220. Thus, the processor 210 may perform operations described in the following embodiments, and the operations described in the following embodiments as being performed by the relay device 200 or the detailed components (e.g., 210 to 250 of FIG. 3) included in the relay device 200 may be considered as being performed by the processor 210 unless otherwise described.

The memory 220 may store various programs or data. The memory 220 may include a storage medium or a combination of storage mediums such as a ROM, a RAM, a hard disk, a CD-ROM, and a DVD. The memory 220 may not be separately provided and may be included in the processor 210. The memory 220 may include volatile memory, nonvolatile memory, or a combination of volatile memory and nonvolatile memory. The memory 220 may store a program or at least one instruction for performing operations according to embodiments described below. The memory 220 may provide the stored data to the processor 210 at the request of the processor 210.

The first communication module 230 may exchange signals (e.g., control commands and data) with an external device by wire or wireless. The first communication module 230 may include a communication chipset that supports various communication technologies. For example, the first communication module 230 may include a short-range communicator and/or a long-range communicator. The short-range communicator may include, but is not limited to, a Bluetooth communicator, a ZigBee communicator, an infrared (IrDA) communicator, a WFD communicator, an UWB communicator, and/or an Ant+ communicator. The long-range communicator may include the Internet, a computer network (e.g., LAN or WAN), and/or a mobile communicator. The mobile communicator may include, but is not limited to, a 3G module, a 4G module, a 5G module, an LTE module, an NB-IoT module, and/or an LTE-M module. In an embodiment of the disclosure, the first communication module 230 may support the first wireless communication technology described above.

The second communication module 240 may exchange signals (e.g., control commands and data) with an external device by wire or wireless. The second communication module 240 may include a communication chipset that supports various communication technologies. For example, the second communication module 240 may include a short-range communicator and/or a long-range communicator. The short-range communicator may include, but is not limited to, a Bluetooth communicator, a ZigBee communicator, an infrared (IrDA) communicator, a WFD communicator, an UWB communicator, and/or an Ant+ communicator. The long-range communicator may include the Internet, a computer network (e.g., LAN or WAN), and/or a mobile communicator. The mobile communicator may include, but is not limited to, a 3G module, a 4G module, a 5G module, an LTE module, an NB-IoT module, and/or an LTE-M module. In another embodiment of the disclosure, the second communication module 240 may support the second wireless communication technology described above.

In yet another embodiment of the disclosure, the first communication module 230 may support a wireless communication technology having a higher maximum data rate than the second communication module 240. For example, the first communication module 230 may support WiFi, and the second communication module 240 may support high-speed Bluetooth.

In yet another embodiment of the disclosure, the first communication module 230 and the second communication module 240 may be implemented as one chipset capable of performing both the operation of the first communication module 230 and the operation of the second communication module 240. For example, the first communication module 230 and the second communication module 240 may be implemented as an integrated chipset that supports both WiFi and high-speed Bluetooth.

The input/output interface 250 may include an input interface (e.g., a touch screen, a hard button, and/or a microphone) for receiving an input of control commands or information from the user, and an output interface (e.g., a display panel and/or a speaker) for displaying the execution result of an operation according to the user's control or the state of the relay device 200. In yet another embodiment of the disclosure, the relay device 200 may receive, through the input/output interface 250, a user input for triggering a relay and/or a user input for designating a target sink device.

FIG. 4 illustrates a configuration of a sink device 300 according to an embodiment of the disclosure.

Referring to FIG. 4, the sink device 300 may include a processor 310, a memory 320, a communication module 330, and an audio output unit 340. However, the components of the sink device 300 are not limited thereto. For example, the sink device 300 may further include a microphone for receiving a user's voice or a noise around the user.

The processor 310 may control a series of processes such that the sink device 300 operates according to embodiments described below. The processor 310 may include one or more processors. The one or more processors included in the processor 310 may include circuitry such as an SoC or an IC. The one or more processors included in the processor 310 may include a general-purpose processor such as a CPU, an MPU, an AP, or a DSP, a dedicated graphics processor such as a GPU or a VPU, a dedicated artificial intelligence processor such as an NPU, or a dedicated communication processor such as a CP. When the one or more processors included in the processor 310 include a dedicated artificial intelligence processor, the dedicated artificial intelligence processor may be designed with a hardware structure specialized for processing of a particular artificial intelligence model.

The processor 310 may write data in the memory 320 and read data stored in the memory 320. The processor 310 may process data according to a predefined operation rule or an artificial intelligence model by executing a program or at least one instruction stored in the memory 320. Thus, the processor 310 may perform operations described in the following embodiments, and the operations described in the following embodiments as being performed by the sink device 300 or the detailed components (e.g., 310 to 340 of FIG. 4) included in the sink device 300 may be considered as being performed by the processor 310 unless otherwise described.

The memory 320 may store various programs or data. The memory 320 may include a storage medium or a combination of storage mediums such as a ROM, a RAM, a hard disk, a CD-ROM, and a DVD. The memory 320 may not be separately provided and may be included in the processor 310. The memory 320 may include volatile memory, nonvolatile memory, or a combination of volatile memory and nonvolatile memory. The memory 320 may store a program or at least one instruction for performing operations according to embodiments described below. The memory 320 may provide the stored data to the processor 310 at the request of the processor 310.

The communication module 330 may exchange signals (e.g., control commands and data) with an external device by wire or wireless. The communication module 330 may include a communication chipset that supports various communication technologies. For example, the communication module 330 may include a short-range communicator and/or a long-range communicator. The short-range communicator may include, but is not limited to, a Bluetooth communicator, a ZigBee communicator, an infrared (IrDA) communicator, a WFD communicator, an UWB communicator, and/or an Ant+ communicator. The long-range communicator may include the Internet, a computer network (e.g., LAN or WAN), and/or a mobile communicator. The mobile communicator may include, but is not limited to, a 3G module, a 4G module, a 5G module, an LTE module, an NB-IoT module, and/or an LTE-M module. In an embodiment of the disclosure, the communication module 330 may support the second wireless communication technology described above.

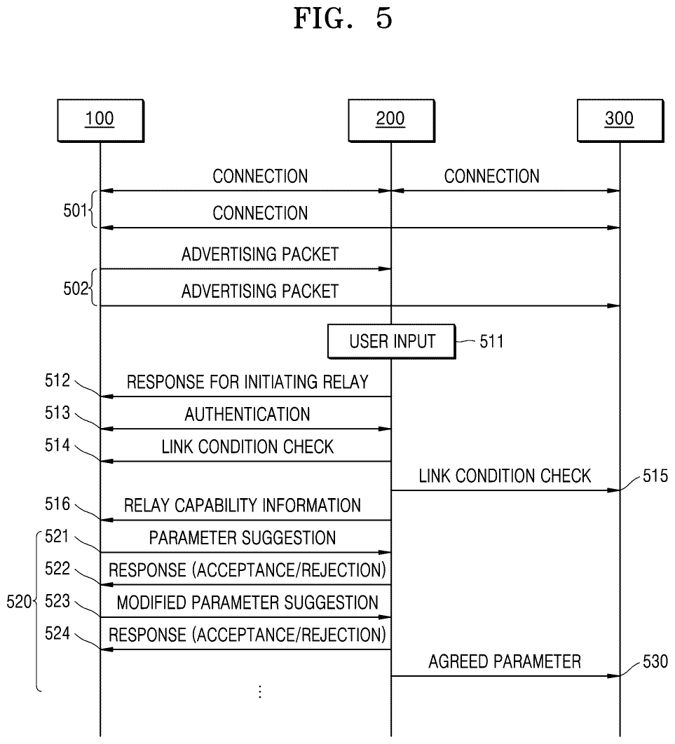

FIG. 5 illustrates an example of a process in which an audio transmission system prepares an audio relay, according to an embodiment of the disclosure.

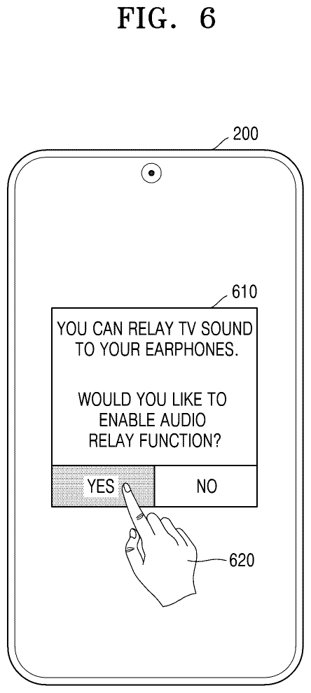

FIG. 6 illustrates an example in which a relay device receives a first user input for triggering a relay, according to an embodiment of the disclosure.

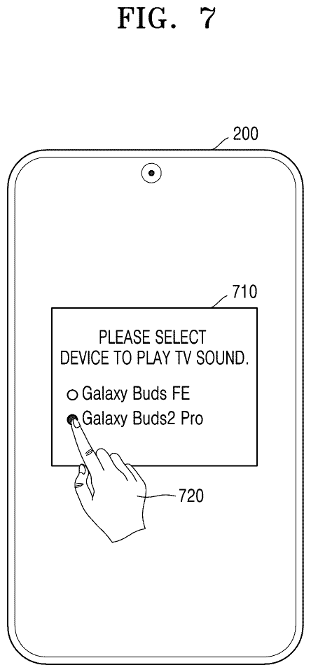

FIG. 7 illustrates an example in which a relay device receives a second user input for designating a target sink device, according to an embodiment of the disclosure.

Referring to FIG. 5, in operation 501, the source device 100, the relay device 200, and the sink device 300 may be connected to each other. In an embodiment of the disclosure, operation 501 may be processed by using the first wireless communication technology, the second wireless communication technology, and/or the third wireless communication technology. For example, the source device 100 and the relay device 200 may be connected to each other by using the first wireless communication technology. The relay device 200 and the sink device 300 may be connected to each other by using the second wireless communication technology. The source device 100 and the sink device 300 may be connected to each other by using the third wireless communication technology. However, the wireless communication technology used for operation 501 is not limited thereto. In another embodiment of the disclosure, “connected” may mean that two devices are in a state of being able to recognize each other and exchange data with each other. Terms such as “paired” and “matched” may be used instead of “connected”.

As an example, the source device 100 and the sink device 300 may be connected to each other as follows by using the third wireless communication technology. The sink device 300 may switch to an advertisement mode and broadcast an advertising packet notifying that the sink device 300 is a connectable device. The source device 100 may switch to a scan mode and receive the advertising packet of the sink device 300. When the source device 100 receives a user input indicating a connection with the sink device 300, the source device 100 may transmit a connection request to the sink device 300. When the sink device 300 accepts the connection request of the source device 100, the source device 100 may be connected to the sink device 300.

When the connection is completed, the source device 100 may store the connection information of the sink device 300 in the memory 120 (see FIG. 2), and the sink device 300 may store the connection information of the source device 100 in the memory 320 (see FIG. 4). For example, the connection information may include, but is not limited to, an identifier (e.g., a Media Access Control (MAC) address) of the counterpart device, a link key for establishing an encrypted connection, and/or a name of the counterpart device.

When the connection is completed, the source device 100 may transmit an audio to the sink device 300 and the sink device 300 may play the received audio.

Similarly, the relay device 200 and the sink device 300 may be connected to each other, and the source device 100 and the relay device 200 may be connected to each other.

In operation 502, the source device 100 may broadcast an advertising packet including a relay status of the source device 100 at certain intervals. In yet another embodiment of the disclosure, the relay status may include whether the source device 100 is relaying. For example, when the source device 100 is directly transmitting an audio to the sink device 300 or is not transmitting an audio to an external device, the relay status may be “open” indicating that the source device 100 is not relaying. When the source device 100 is transmitting an audio to the relay device 200, the relay status may be “closed” indicating that the source device 100 is relaying.

In yet another embodiment of the disclosure, the advertising packet may include an identifier of a target device to which the source device 100 is transmitting an audio. For example, when the source device 100 is transmitting an audio to the sink device 300, the advertising packet may include an identifier of the sink device 300 as an identifier of the target device.

In operation 511, when the relay device 200 receives the advertising packet of the source device 100, the relay device 200 may receive a user input associated with the relay through the input/output interface 250 (see FIG. 3). In yet another embodiment of the disclosure, the user input may include at least one of a first user input for triggering a relay or a second user input for designating a target sink device among the sink devices paired with the relay device 200.

For example, as illustrated in FIG. 6, when the relay device 200 receives the advertising packet of the source device 100, the relay device 200 may display, on a display panel, a popup 610 for asking the user whether to trigger a relay. The relay device 200 may receive a user input about whether to trigger a relay through a touch input 620. When the user selects “Yes”, the relay device 200 may further perform operations described below.

For example, as illustrated in FIG. 7, when a plurality of sink devices 300 are paired with the relay device 200, the relay device 200 may display, on the display panel, a popup 710 for asking which sink device 300 among the plurality of sink devices 300 paired with the relay device 200 is to play an audio. The relay device 200 may receive a second user input for designating a target sink device through a touch input 720.

Referring back to FIG. 5, in operation 512, the relay device 200 may transmit, to the source device 100, a response for initiating a relay, based on the first user input for triggering a relay. In yet another embodiment of the disclosure, the response for initiating a relay may include at least one of a relay status indicating a relay request or an identifier of the relay device 200. For example, the relay status may be “request” indicating that the relay device 200 requests an audio relay.

In operation 513, the source device 100 may authenticate the relay device 200, and the relay device 200 may authenticate the source device 100. Operation 513 may be a security operation and may be understood as a process of determining whether to allow audio transmission to the relay device 200 that has requested a relay. For example, when the user of the relay device 200 is the same as the user of the source device 100, the audio transmission may be allowed, but when the user of the relay device 200 is different from the user of the source device 100, the audio transmission may not be allowed. When a next-door relay device receives the advertising packet of the source device 100 and transmits, to the source device 100, a response for initiating a relay, the audio transmission may not be allowed.

In yet another embodiment of the disclosure, operation 513 may be performed in the way of authenticating an account logged in the source device 100 and the relay device 200. As an example, when the same account is logged in the source device 100 and the relay device 200, the audio relay may be allowed. As another example, when the account logged in the relay device 200 is the same as an account registered as a family account in the source device 100, the audio relay may be allowed. In the present example, the account may include an account registered in the manufacturer of the source device 100 and the relay device 200 and may also include an account of a third-party application having no hardware dependency.

In operation 514, the relay device 200 may check the link condition of the first wireless communication technology with the source device 100. In yet another embodiment of the disclosure, the link condition of the first wireless communication technology may indicate the current communication quality and may include, but is not limited to, a data rate, a bandwidth, a delay time, a signal strength, and/or a packet loss rate.

In operation 515, the relay device 200 may check the link condition of the second wireless communication technology with the sink device 300. In yet another embodiment of the disclosure, the link condition of the second wireless communication technology may indicate the current communication quality and may include, but is not limited to, a data rate, a bandwidth, a delay time, a signal strength, and/or a packet loss rate.

In operation 516, the relay device 200 may transmit, to the source device 100, relay capability information including an available maximum data rate and an identifier of the sink device 300 paired with the relay device 200. When a plurality of sink devices 300 are paired with the relay device 200, the relay capability information may include an identifier of each of the plurality of sink devices 300. The available maximum data rate may be determined based on the link condition check result of operation 515.

In operation 520, the source device 100 and the relay device 200 may negotiate on at least one parameter for a relay. For example, in operation 521, the source device 100 may transmit a parameter suggestion to the relay device 200, and in operation 522, the relay device 200 may transmit a response to the parameter suggestion to the source device 100. When the response of the relay device 200 is a response for rejecting the parameter suggestion, the source device 100 may transmit a modified parameter suggestion to the relay device 200 in operation 523 and the relay device 200 may transmit a response to the modified parameter suggestion to the source device 100 in operation 524. Similarly, operation 520 may continue until the relay device 200 transmits a response for accepting the parameter suggestion of the source device 100.

In yet another embodiment of the disclosure, the parameter for a relay may include at least one of an identifier of the target sink device, a data rate for audio transmission, or a time offset corresponding to a time at which the source device 100 initiates an audio relay.

For example, the identifier of the target sink device may represent an identifier of the sink device that will play an audio. When the source device 100 is directly transmitting an audio to the sink device 300, the identifier of the target sink device may be an identifier of the sink device 300. When the relay device 200 is paired with the sink device 300, the relay device 200 may transmit, to the source device 100, a response for accepting the parameter suggestion of the source device 100 in operation 522. When the relay device 200 is not paired with the sink device 300, the relay device 200 may transmit, to the source device 100, a response for rejecting the parameter suggestion of the source device 100 in operation 522.

For example, the data rate for audio transmission may be determined based on the audio quality within the range of the available maximum data rate described above. When the audio quality is high (e.g., lossless compression), the data rate for audio transmission may be determined to be relatively high, and when the audio quality is low (e.g., lossy compression), the data rate for audio transmission may be determined to be relatively low.

For example, the time offset corresponding to the time at which an audio relay is initiated may be the time from the time at which the source device 100 transmits a parameter suggestion to the relay device 200 (e.g., operation 521) to the time at which an audio relay is initiated. The time offset may be determined based on whether the source device 100 is directly transmitting an audio to the sink device 300 and/or the processing time required for the relay device 200 to convert an audio into a form suitable for the second wireless communication technology (e.g., increasing or decreasing the size of a data packet transmitted at once).

In yet another embodiment of the disclosure, the parameter for a relay may further include an identifier of the source device 100, an identifier of the relay device 200, and a relay status message.

For example, the relay status message may include, but is not limited to, “Request” indicating that the source device 100 requests a relay to the relay device 200, “Accept” indicating that the relay device 200 accepts the parameter suggestion of the source device 100, “Reject” indicating that the relay device 200 rejects the parameter suggestion of the source device 100, “Add SNK” indicating that the source device 100 requests the relay device 200 to pair with another sink device, and “Add Done” indicating that the relay device 200 notifies the source device 100 that pairing with another sink device is completed.

In yet another embodiment of the disclosure, the process of exchanging signals between the source device 100 and the relay device 200 to prepare a relay (e.g., operations 512, 513, 516, 520, 521, 522, 523, and 524) may be performed between the source device 100 and the relay device 200 by using the first wireless communication technology and/or the third wireless communication technology or may be performed via an external cloud server by using another wired/wireless communication technology such as the Internet.

When the parameter agreement for a relay is completed in operation 520, the relay device 200 may transmit the agreed parameter to the sink device 300 in operation 530.

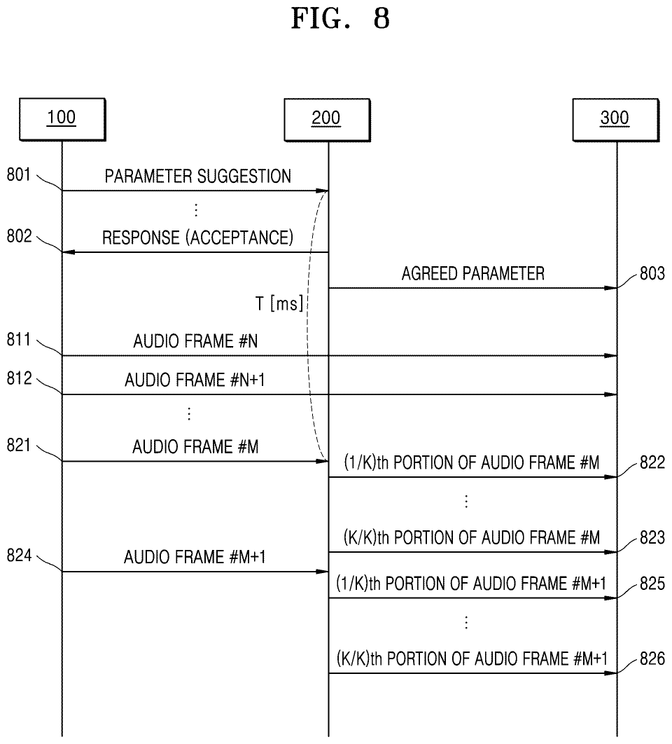

FIG. 8 illustrates an example of a process in which an audio transmission system relays an audio, according to an embodiment of the disclosure.

FIG. 8 describes a case where an audio is directly transmitted from the source device 100 to the sink device 300 and then relayed through the relay device 200. However, this is merely an example, and an audio may be relayed through the relay device 200 from the start in the audio transmission system.

Referring to FIG. 8, operations 801 and 802 may indicate that the source device 100 and the relay device 200 negotiate on at least one parameter for a relay, and operation 803 may indicate that the relay device 200 transmits the agreed parameter to the sink device 300. Operations 801 and 802 may correspond to operations 520 of FIG. 5 and operation 803 may correspond to operations 530 of FIG. 5, and thus, redundant descriptions thereof will be omitted for conciseness.

When the parameter agreement for a relay is completed, an audio relay may be initiated based on the agreed parameter.

Operations 811 and 812 may indicate that the source device 100 directly transmits an audio frame to the sink device 300. In an embodiment of the disclosure, an audio frame may be understood as the unit of audio transmission in which the entire audio is segmented in certain time units. For example, an audio frame may be data in which the entire audio is segmented in 7.5 ms or 10 ms units.

In operation 811, the source device 100 may transmit an audio frame #N to the sink device 300, and in operation 812, the source device 100 may transmit an audio frame #N+1 to the sink device 300. The audio frame transmission from the source device 100 to the sink device 300 may be performed until a time offset (e.g., T [ms]) has passed from operation 801. The time offset may be the time offset agreed in operation 520 of FIG. 5.

An audio relay may be initiated after the time offset (e.g., T [ms]) from operation 801.

In operation 821, the source device 100 may transmit an audio frame #M to the relay device 200 by using the first wireless communication technology.

In operations 822 and 823, the relay device 200 may segment the audio frame #M into K portions and transmit the segmented audio frame #M to the sink device 300 by using the second wireless communication technology. In another embodiment of the disclosure, K may be determined based on the size of a first data packet that may be transmitted at once by using the first wireless communication technology and the size of a second data packet that may be transmitted at once by using the second wireless communication technology. For example, when the size of the first data packet and the size of the second data packet are equal to each other, K may be 1, and when the size of the first data packet is 10 times the size of the second data packet, K may be 10.

In operation 824, the source device 100 may transmit an audio frame #M+1 to the relay device 200 by using the first wireless communication technology, and in operations 825 and 826, the relay device 200 may segment the audio frame #M+1 into K portions and transmit the segmented audio frame #M+1 to the sink device 300 by using the second wireless communication technology.

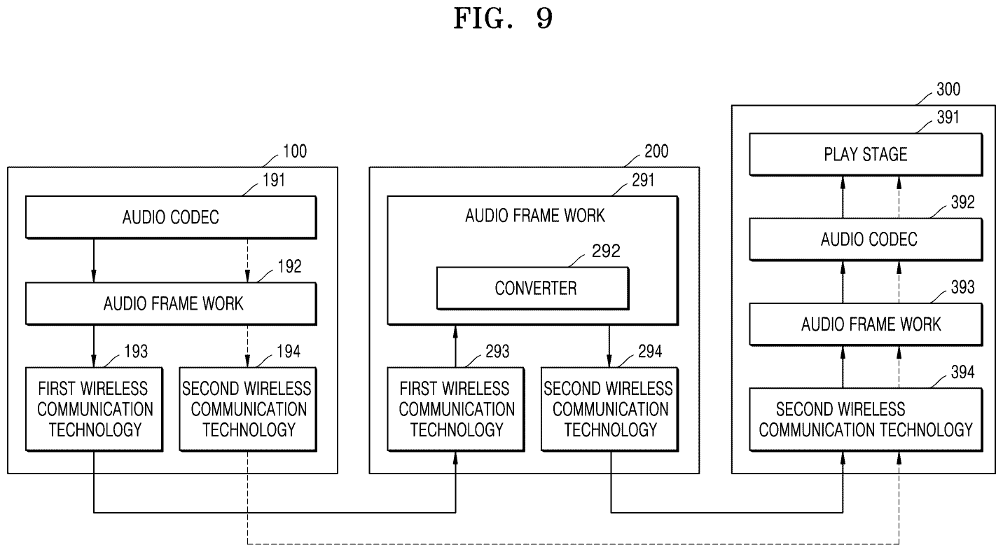

FIG. 9 is a logical block diagram illustrating an example of an audio processing process in an audio transmission system according to an embodiment of the disclosure.

The blocks illustrated in FIG. 9 may be logical blocks for performing an operation of transmitting an audio in the above audio transmission system, and each block may be implemented by software or a combination of software and hardware. For example, an audio framework block (192, 291, 393) may be implemented by software, and a first wireless communication technology block (193, 293), a second wireless communication technology block (294, 394), and a third wireless communication technology block 194 may be implemented by a combination of software and hardware; however, the disclosure is not limited thereto.

Referring to FIG. 9, the source device 100 may include an audio codec block 191, an audio framework block 192, a first wireless communication technology block 193, and a third wireless communication technology block 194. The relay device 200 may include an audio framework block 291 including a converter 292, a first wireless communication technology block 293, and a second wireless communication technology block 294. The sink device 300 may include a play stage block 391, an audio codec block 392, an audio framework block 393, and a second wireless communication technology block 394. As illustrated in FIG. 9, a solid arrow may represent a path along which an audio is relayed through the relay device 200, and a dotted arrow may represent a path along which an audio is directly transmitted from the source device 100 to the sink device 300.

The audio codec block (191, 392) may encode an audio with a certain quality and decode the encoded audio. For example, the audio codec block 191 may include, but is not limited to, a lossless compression codec (e.g., Free Lossless Audio Codec (FLAC)) and/or a lossy compression codec (e.g., MP3 or Advanced Audio Coding (AAC)).

The audio framework block (192, 291, 393) may include software (or an application) that defines operations performed for an audio relay in the audio transmission system (e.g., operations 512 to 516 and operations 520 to 524 of FIG. 5). The audio framework block (192, 291, 393) may function as an upper layer of a physical layer and a link layer defined in the first wireless communication technology block (193, 293), the second wireless communication technology block (294, 394), and/or the third wireless communication technology block 194.

The first wireless communication technology block (193, 293) may include software (or an application) that defines a rule for transmitting an audio by using the first wireless communication technology and hardware that transmits an audio to an external device. For example, the first wireless communication technology block (193, 293) may define a physical layer (e.g., bit transmission, a medium type, or a transmission rate) and/or a link layer (e.g., a size of a data frame, a mechanism for detecting and correcting an error that may occur during transmission, a flow control for preventing a data overflow, or a MAC address).

The second wireless communication technology block (294, 394) may include software (or an application) that defines a rule for transmitting an audio by using the second wireless communication technology and hardware that transmits an audio to an external device. For example, the second wireless communication technology block (294, 394) may define a physical layer (e.g., bit transmission, a medium type, or a transmission rate) and/or a link layer (e.g., a size of a data frame, a mechanism for detecting and correcting an error that may occur during transmission, a flow control for preventing a data overflow, or a MAC address).

The third wireless communication technology block 194 may include software (or an application) that defines a rule for transmitting an audio by using the third wireless communication technology and hardware that transmits an audio to an external device. For example, the third wireless communication technology block 194 may define a physical layer (e.g., bit transmission, a medium type, or a transmission rate) and/or a link layer (e.g., a size of a data frame, a mechanism for detecting and correcting an error that may occur during transmission, a flow control for preventing a data overflow, or a MAC address).

When an audio is relayed through the relay device 200 as illustrated by the solid arrow in FIG. 9, because the data rate of the first wireless communication technology and the second wireless communication technology are higher than the data rate of the third wireless communication technology, the distance from an audio source may be relatively shortened from the viewpoint of the sink device 300. Thus, the throughput of audio transmission may be improved and the transmission delay time of a data packet may be reduced and thus the audio quality may be improved and the audio interruption may be reduced. When an audio is relayed through the relay device 200, because the antenna reception gain of the relay device 200 is higher than the antenna reception gain of the sink device 300, the packet error rate may be reduced as compared to when an audio is directly transmitted.

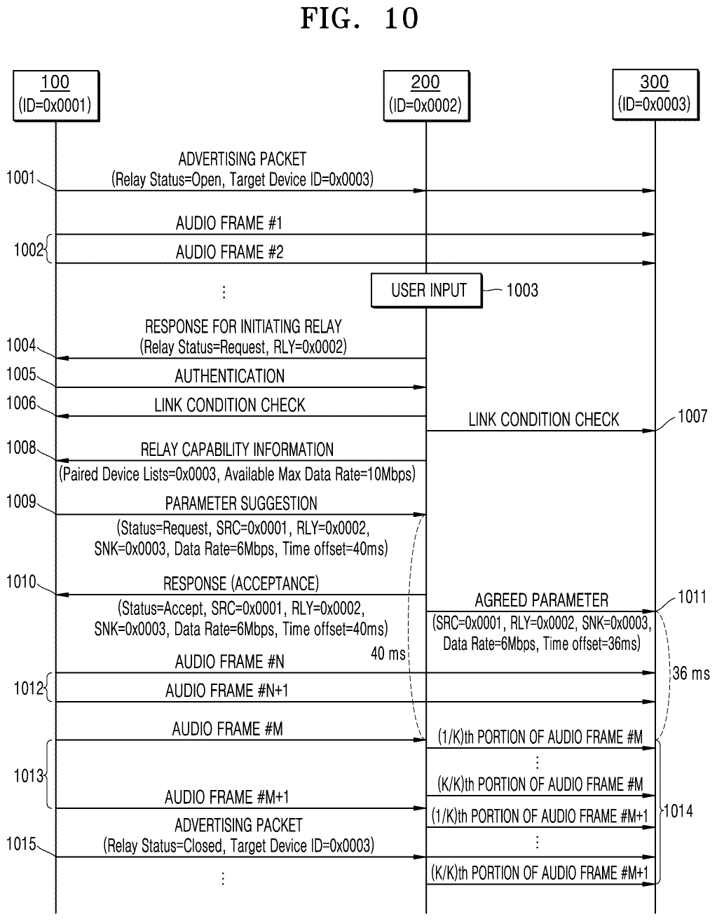

FIGS. 10, 11, 12A, 12B, 13A, and 13B illustrate examples of operation scenarios of an audio transmission system according to various embodiments of the disclosure.

FIG. 10 illustrates a situation in which a relay is triggered by a user input while the source device 100 directly transmits an audio to the sink device 300. In the example of FIG. 10, it may be assumed that the identifier of the source device 100 is 0x0001, the identifier of the relay device 200 is 0x0002, and the identifier of the sink device 300 is 0x0003. In FIG. 10, an operation (e.g., operation 501 of FIG. 5) in which the source device 100, the relay device 200, and the sink device 300 are connected to each other is omitted. In the following description, redundant descriptions with those of FIGS. 5 to 7 will be omitted for conciseness.

In operation 1001, the source device 100 may periodically broadcast an advertising packet having a relay status of “Open” and a target device identifier of 0x0003. The advertising packet of operation 1001 may indicate that the source device 100 is not performing a relay and may perform a relay with the sink device 300 as a target device.

In operation 1002, the source device 100 may transmit an audio frame to the sink device 300 by using the third wireless communication technology.

In operation 1003, the relay device 200 may receive a user input for triggering a relay.

In operation 1004, the relay device 200 may transmit, to the source device 100, a response for initiating a relay having a relay status of “Request” and a relay device identifier of 0x0002. The response for initiating a relay in operation 1004 may indicate that the relay device 200 requests a relay.

In operation 1005, the source device 100 may authenticate the relay device 200.

In operation 1006, the relay device 200 may check the link condition of the first wireless communication technology with the source device 100.

In operation 1007, the relay device 200 may check the link condition of the second wireless communication technology with the sink device 300.

In operation 1008, the relay device 200 may transmit, to the source device 100, relay capability information having a paired device list of 0x0003 and an available maximum data rate of 10 Mbps. The relay capability information of operation 1008 may mean that the sink device 300 is paired with the relay device 200 and may transmit an audio at a maximum data rate of 10 Mbps by using the second wireless communication technology.

In operation 1009, the source device 100 may transmit, to the relay device 200, a parameter suggestion having a status of “Request”, a source device identifier of 0x0001, a relay device identifier of 0x0002, a sink device identifier of 0x0003, a data rate of 6 Mbps, and a time offset of 40 ms. The parameter suggestion of operation 1009 may mean that the source device 100 transmits an audio to the relay device 200 after 40 ms and the relay device 200 transmits an audio to the sink device 300 at a data rate of 6 Mbps.

In operation 1010, the relay device 200 may transmit, to the source device 100, a response having a status of “Accept”, a source device identifier of 0x0001, a relay device identifier of 0x0002, a sink device identifier of 0x0003, a data rate of 6 Mbps, and a time offset of 40 ms. The response of operation 1010 may mean that the relay device 200 accepts the parameter suggestion of operation 1009.

In operation 1011, the relay device 200 may transmit, to the sink device 300, an agreed parameter having a source device identifier of 0x0001, a relay device identifier of 0x0002, a sink device identifier of 0x0003, a data rate of 6 Mbps, and a time offset of 36 ms. The time offset of 36 ms in operation 1011 is merely an example based on the assumption that 4 ms has passed from operation 1009, and the disclosure is not limited thereto.

In operation 1012, the source device 100 may transmit an audio frame to the sink device 300 by using the third wireless communication technology until 40 ms has passed from operation 1009.

In operation 1013, the source device 100 may transmit an audio frame to the relay device 200 by using the first wireless communication technology, and in operation 1014, the relay device 200 may transmit an audio frame segmented into K portions to the sink device 300 by using the second wireless communication technology.

In operation 1015, the source device 100 may periodically broadcast an advertising packet having a relay status of “Closed” and a target device identifier of 0x0003. The advertising packet of operation 1015 may indicate that the source device 100 is currently transmitting an audio to the sink device 300 through a relay (rather than directly).

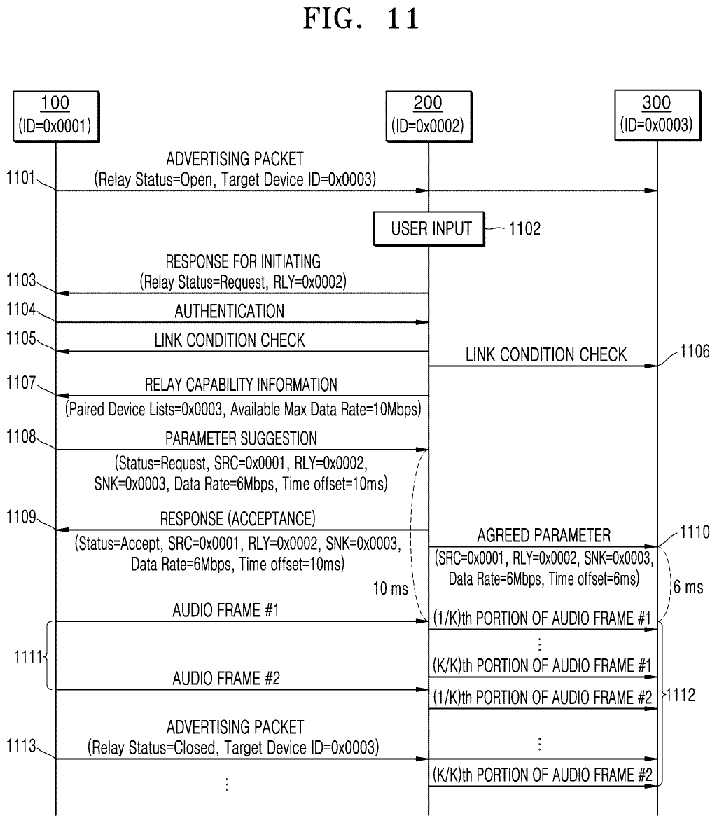

FIG. 11 illustrates a situation in which a relay is triggered by a user input when the source device 100 does not directly transmit an audio to the sink device 300. In the example of FIG. 11, it may be assumed that the identifier of the source device 100 is 0x0001, the identifier of the relay device 200 is 0x0002, and the identifier of the sink device 300 is 0x0003. In FIG. 11, an operation (e.g., operation 501 of FIG. 5) in which the source device 100, the relay device 200, and the sink device 300 are connected to each other is omitted. In the following description, redundant descriptions of operations with those of FIG. 10 will be omitted for conciseness.

In operation 1101, the source device 100 may periodically broadcast an advertising packet having a relay status of “Open” and a target device identifier of 0x0003.

In operation 1102, the relay device 200 may receive a user input for triggering a relay.

In operation 1103, the relay device 200 may transmit, to the source device 100, a response for initiating a relay having a relay status of “Request” and a relay device identifier of 0x0002.

In operation 1104, the source device 100 may authenticate the relay device 200.

In operation 1105, the relay device 200 may check the link condition of the first wireless communication technology with the source device 100.

In operation 1106, the relay device 200 may check the link condition of the second wireless communication technology with the sink device 300.

In operation 1107, the relay device 200 may transmit, to the source device 100, relay capability information having a paired device list of 0x0003 and an available maximum data rate of 10 Mbps.

In operation 1108, the source device 100 may transmit, to the relay device 200, a parameter suggestion having a status of “Request”, a source device identifier of 0x0001, a relay device identifier of 0x0002, a sink device identifier of 0x0003, a data rate of 6 Mbps, and a time offset of 10 ms. The parameter suggestion of operation 1108 may mean that the source device 100 transmits an audio to the relay device 200 after 10 ms and the relay device 200 transmits an audio to the sink device 300 at a data rate of 6 Mbps. In the example of FIG. 11, because an operation corresponding to operation 1012 of FIG. 10 is omitted, the time offset in operation 1108 may be determined to be smaller than the time offset in operation 1009.

In operation 1109, the relay device 200 may transmit, to the source device 100, a response having a status of “Accept”, a source device identifier of 0x0001, a relay device identifier of 0x0002, a sink device identifier of 0x0003, a data rate of 6 Mbps, and a time offset of 10 ms.

In operation 1110, the relay device 200 may transmit, to the sink device 300, an agreed parameter having a source device identifier of 0x0001, a relay device identifier of 0x0002, a sink device identifier of 0x0003, a data rate of 6 Mbps, and a time offset of 6 ms.

In operation 1111, the source device 100 may transmit an audio frame to the relay device 200 after 10 ms from operation 1108 by using the first wireless communication technology, and in operation 1112, the relay device 200 may transmit an audio frame segmented into K portions to the sink device 300 by using the second wireless communication technology.

In operation 1113, the source device 100 may periodically broadcast an advertising packet having a relay status of “Closed” and a target device identifier of 0x0003.

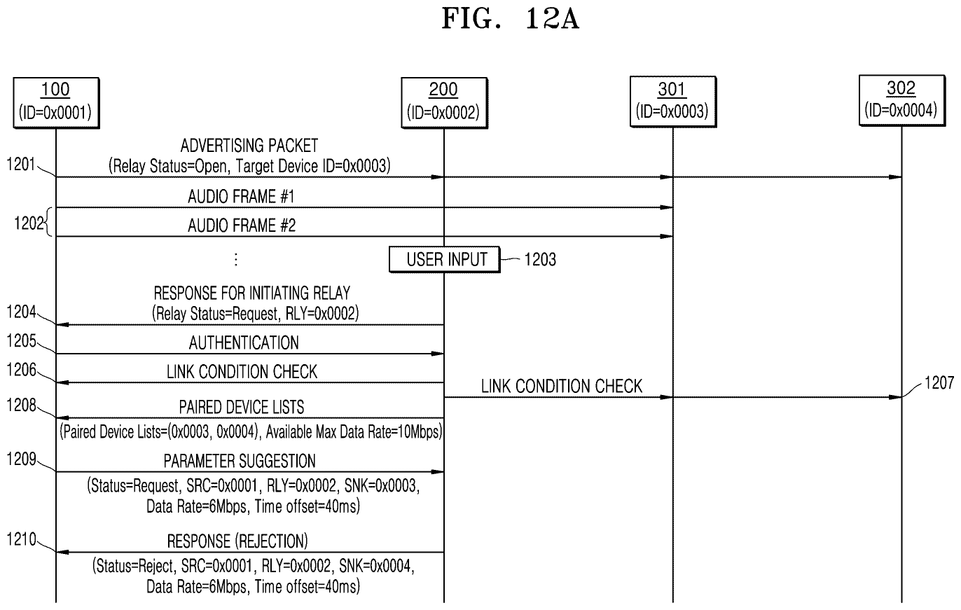

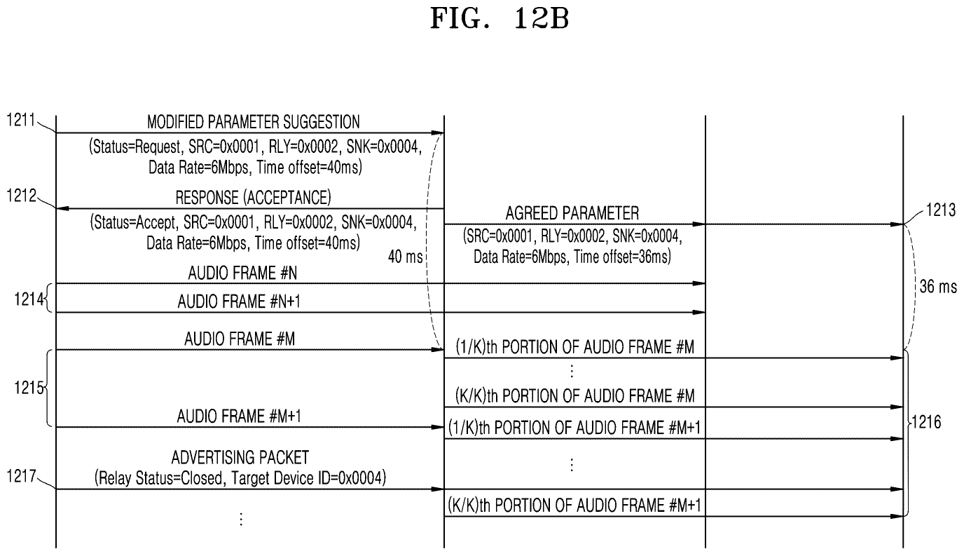

FIGS. 12A and 12B illustrate a situation in which a relay is triggered by a user input while the source device 100 directly transmits an audio to a first sink device 301 according to various embodiment of the disclosure.

Referring to FIGS. 12A and 12B, it may be assumed that the relay device 200 is paired with the first sink device 301 and a second sink device 302 and receives a user input for designating the second sink device 302 as a target sink device. In the example of FIGS. 12A and 12B, it may be assumed that the identifier of the source device 100 is 0x0001, the identifier of the relay device 200 is 0x0002, the identifier of the first sink device 301 is 0x0003, and the identifier of the second sink device 302 is 0x0004. In FIGS. 12A and 12B, an operation (e.g., operation 501 of FIG. 5) in which the source device 100, the relay device 200, the first sink device 301, and the second sink device 302 are connected to each other is omitted. In the following description, redundant descriptions of operations with those of FIGS. 10 and 11 will be omitted for conciseness.

In operation 1201, the source device 100 may periodically broadcast an advertising packet having a relay status of “Open” and a target device identifier of 0x0003. The advertising packet of operation 1201 may indicate that the source device 100 is not performing a relay and may perform a relay with the first sink device 301 as a target device.

In operation 1202, the source device 100 may transmit an audio frame to the first sink device 301 by using the third wireless communication technology.

In operation 1203, the relay device 200 may receive a first user input for triggering a relay and a second user input for designating the second sink device 302 as a target sink device.

In operation 1204, the relay device 200 may transmit, to the source device 100, a response for initiating a relay having a relay status of “Request” and a relay device identifier of 0x0002.

In operation 1205, the source device 100 may authenticate the relay device 200.

In operation 1206, the relay device 200 may check the link condition of the first wireless communication technology with the source device 100.

In operation 1207, the relay device 200 may check the link condition of the second wireless communication technology with the first sink device 301 and the second sink device 302.

In operation 1208, the relay device 200 may transmit, to the source device 100, relay capability information having a paired device list of (0x0003, 0x0004) and an available maximum data rate of 10 Mbps. The relay capability information of operation 1208 may mean that the first sink device 301 and the second sink device 302 are paired with the relay device 200 and may transmit an audio at a maximum data rate of 10 Mbps by using the second wireless communication technology.

In operation 1209, the source device 100 may transmit, to the relay device 200, a parameter suggestion having a status of “Request”, a source device identifier of 0x0001, a relay device identifier of 0x0002, a sink device identifier of 0x0003, a data rate of 6 Mbps, and a time offset of 40 ms. The parameter suggestion of operation 1209 may mean that the source device 100 transmits an audio to the relay device 200 after 40 ms and the relay device 200 transmits an audio to the first sink device 301 at a data rate of 6 Mbps.

In operation 1210, the relay device 200 may transmit, to the source device 100, a response having a status of “Reject”, a source device identifier of 0x0001, a relay device identifier of 0x0002, a sink device identifier of 0x0004, a data rate of 6 Mbps, and a time offset of 40 ms. The response of operation 1210 may mean that the relay device 200 rejects the parameter suggestion of operation 1209 and requests the sink device to be modified to the second sink device 302.

In operation 1211, the source device 100 may transmit, to the relay device 200, a modified parameter suggestion having a status of “Request”, a source device identifier of 0x0001, a relay device identifier of 0x0002, a sink device identifier of 0x0004, a data rate of 6 Mbps, and a time offset of 40 ms. The modified parameter suggestion of operation 1211 may mean that the source device 100 transmits an audio to the relay device 200 after 40 ms and the relay device 200 transmits an audio to the second sink device 302 at a data rate of 6 Mbps.

In operation 1212, the relay device 200 may transmit, to the source device 100, a response having a status of “Accept”, a source device identifier of 0x0001, a relay device identifier of 0x0002, a sink device identifier of 0x0004, a data rate of 6 Mbps, and a time offset of 40 ms. The response of operation 1212 may mean that the relay device 200 accepts the modified parameter suggestion of operation 1211.

In operation 1213, the relay device 200 may transmit, to the first sink device 301 and the second sink device 302, an agreed parameter having a source device identifier of 0x0001, a relay device identifier of 0x0002, a sink device identifier of 0x0004, a data rate of 6 Mbps, and a time offset of 36 ms. The time offset of 36 ms in operation 1213 is merely an example based on the assumption that 4 ms has passed from operation 1211, and the disclosure is not limited thereto.

In operation 1214, the source device 100 may transmit an audio frame to the first sink device 301 by using the third wireless communication technology until 40 ms has passed from operation 1211.

In operation 1215, the source device 100 may transmit an audio frame to the relay device 200 by using the first wireless communication technology, and in operation 1216, the relay device 200 may transmit an audio frame segmented into K portions to the second sink device 302 by using the second wireless communication technology.

In operation 1217, the source device 100 may periodically broadcast an advertising packet having a relay status of “Closed” and a target device identifier of 0x0004. The advertising packet of operation 1217 may indicate that the source device 100 is currently transmitting an audio to the second sink device 302 through a relay (rather than directly).

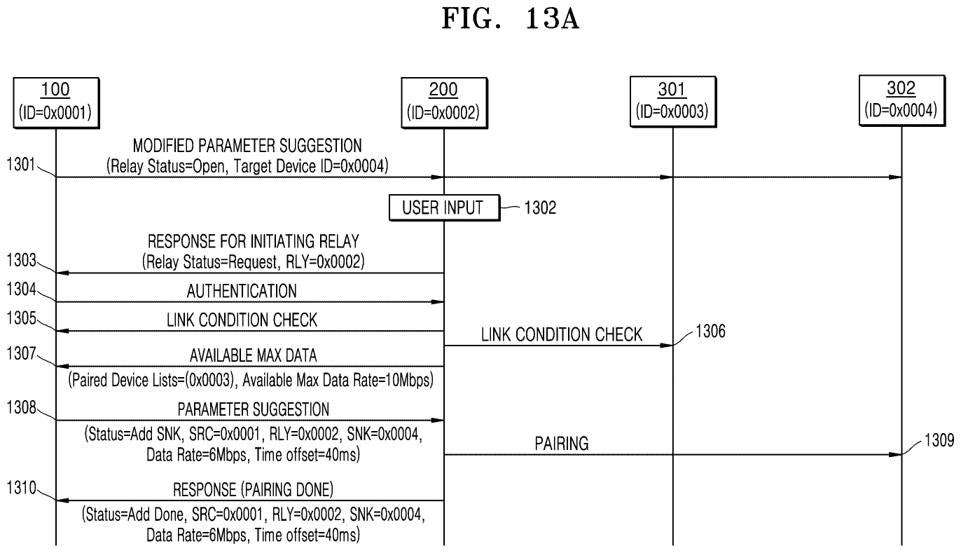

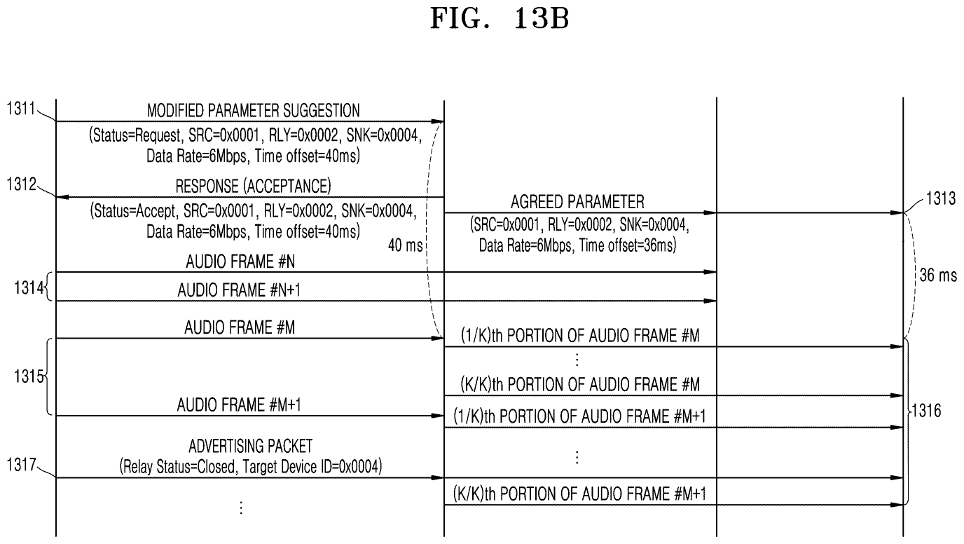

FIGS. 13A and 13B illustrate a situation in which a relay is triggered by a user input while the source device 100 directly transmits an audio to the second sink device 302 according to various embodiments of the disclosure.

In the example of FIGS. 13A and 13B, it may be assumed that the relay device is paired with the first sink device 301 and is not paired with the second sink device 302. In the example of FIGS. 13A and 13B, it may be assumed that the identifier of the source device 100 is 0x0001, the identifier of the relay device 200 is 0x0002, the identifier of the first sink device 301 is 0x0003, and the identifier of the second sink device 302 is 0x0004. In FIGS. 13A and 13B, an operation (e.g., operation 501 of FIG. 5) in which the source device 100, the relay device 200, the first sink device 301, and the second sink device 302 are connected to each other is omitted. In the following description, redundant descriptions of operations with those of FIGS. 10, 11, 12A, and 12B will be omitted for conciseness.

In operation 1301, the source device 100 may periodically broadcast an advertising packet having a relay status of “Open” and a target device identifier of 0x0004. The advertising packet of operation 1301 may indicate that the source device 100 is not performing a relay and may perform a relay with the second sink device 302 as a target device.

In operation 1302, the relay device 200 may receive a user input for triggering a relay.

In operation 1303, the relay device 200 may transmit, to the source device 100, a response for initiating a relay having a relay status of “Request” and a relay device identifier of 0x0002.

In operation 1304, the source device 100 may authenticate the relay device 200.

In operation 1305, the relay device 200 may check the link condition of the first wireless communication technology with the source device 100.

In operation 1306, the relay device 200 may check the link condition of the second wireless communication technology with the first sink device 301.

In operation 1307, the relay device 200 may transmit, to the source device 100, relay capability information having a paired device list of 0x0003 and an available maximum data rate of 10 Mbps. The relay capability information of operation 1307 may mean that the first sink device 301 is paired with the relay device 200 and may transmit an audio at a maximum data rate of 10 Mbps by using the second wireless communication technology.

In operation 1308, the source device 100 may transmit, to the relay device 200, a parameter suggestion having a status of “Add SNK”, a source device identifier of 0x0001, a relay device identifier of 0x0002, a sink device identifier of 0x0004, a data rate of 6 Mbps, and a time offset of 40 ms. The parameter suggestion of operation 1308 may mean that the relay device 200 requests to pair with the second sink device 302. Based on the fact that the relay capability information of operation 1307 does not include the identifier of the second sink device 302, the source device 100 may transmit the parameter suggestion of operation 1308 to the relay device 200.

In operation 1309, the relay device 200 may pair with the second sink device 302.

In operation 1310, the source device 100 may transmit, to the relay device 200, a response having a status of “Add Done”, a source device identifier of 0x0001, a relay device identifier of 0x0002, a sink device identifier of 0x0004, a data rate of 6 Mbps, and a time offset of 40 ms. The response of operation 1310 may mean that the relay device 200 is paired with the second sink device 302.

In operation 1311, the source device 100 may transmit, to the relay device 200, a modified parameter suggestion having a status of “Request”, a source device identifier of 0x0001, a relay device identifier of 0x0002, a sink device identifier of 0x0004, a data rate of 6 Mbps, and a time offset of 40 ms. The modified parameter suggestion of operation 1311 may mean that the source device 100 transmits an audio to the relay device 200 after 40 ms and the relay device 200 transmits an audio to the second sink device 302 at a data rate of 6 Mbps.

In operation 1312, the relay device 200 may transmit, to the source device 100, a response having a status of “Accept”, a source device identifier of 0x0001, a relay device identifier of 0x0002, a sink device identifier of 0x0004, a data rate of 6 Mbps, and a time offset of 40 ms. The response of operation 1312 may mean that the relay device 200 accepts the modified parameter suggestion of operation 1311.

In operation 1313, the relay device 200 may transmit, to the first sink device 301 and the second sink device 302, an agreed parameter having a source device identifier of 0x0001, a relay device identifier of 0x0002, a sink device identifier of 0x0004, a data rate of 6 Mbps, and a time offset of 36 ms. The time offset of 36 ms in operation 1313 is merely an example based on the assumption that 4 ms has passed from operation 1311, and the disclosure is not limited thereto.

In operation 1314, the source device 100 may transmit an audio frame to the first sink device 301 by using the third wireless communication technology until 40 ms has passed from operation 1311.

In operation 1315, the source device 100 may transmit an audio frame to the relay device 200 by using the first wireless communication technology, and in operation 1316, the relay device 200 may transmit an audio frame segmented into K portions to the second sink device 302 by using the second wireless communication technology.

In operation 1317, the source device 100 may periodically broadcast an advertising packet having a relay status of “Closed” and a target device identifier of 0x0004. The advertising packet of operation 1317 may indicate that the source device 100 is currently transmitting an audio to the second sink device 302 through a relay (rather than directly).

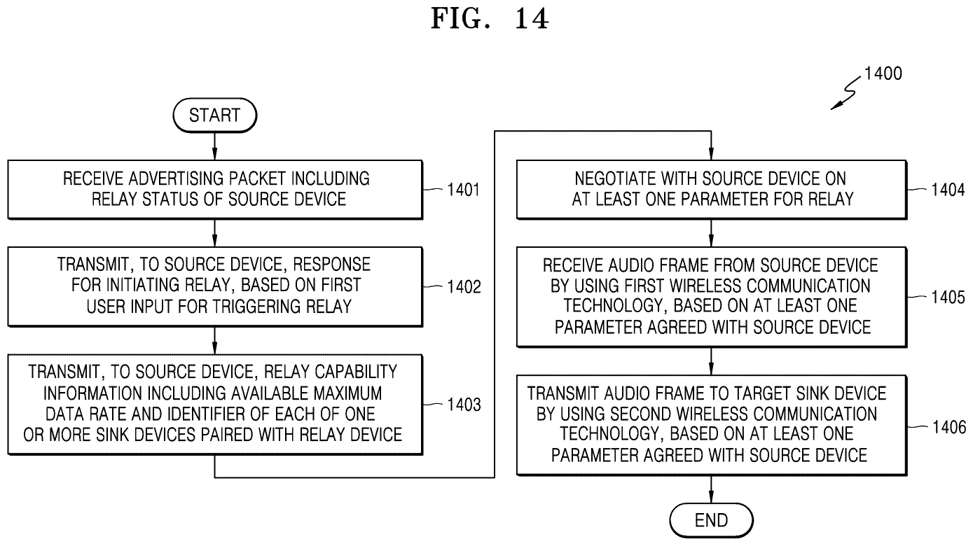

FIG. 14 illustrates an operating method 1400 of a relay device according to an embodiment of the disclosure.

The operations of FIG. 14 may be performed by the relay device 200 of FIG. 3.

In operation 1401, the relay device 200 may receive an advertising packet including a relay status of the source device 100. Operation 1401 may correspond to operation 502 of FIG. 5.

In operation 1402, the relay device 200 may transmit, to the source device 100, a response for initiating a relay, based on a first user input for triggering a relay. Operation 1402 may correspond to operation 512 of FIG. 5.

In operation 1403, the relay device 200 may transmit, to the source device 100, relay capability information including an available maximum data rate and an identifier of each of one or more sink devices 300 paired with the relay device 200. Operation 1403 may correspond to operation 516 of FIG. 5.

In operation 1404, the relay device 200 may negotiate with the source device 100 on at least one parameter for a relay. Operation 1404 may correspond to operations 520 to 524 of FIG. 5, operations 1008 to 1010 of FIG. 10, operations 1107 to 1109 of FIG. 11, operations 1209 to 1212 of FIGS. 12A and 12B, and operations 1307 to 1312 of FIGS. 13A and 13B.

In operation 1405, the relay device 200 may receive an audio frame from the source device by using the first wireless communication technology, based on the at least one parameter agreed with the source device 100. Operation 1405 may correspond to operations 821 and 824 of FIG. 8.

In operation 1406, the relay device 200 may transmit an audio frame to the target sink device by using the second wireless communication technology, based on the at least one parameter agreed with the source device 100. Operation 1406 may correspond to operations 822 to 826 of FIG. 8.

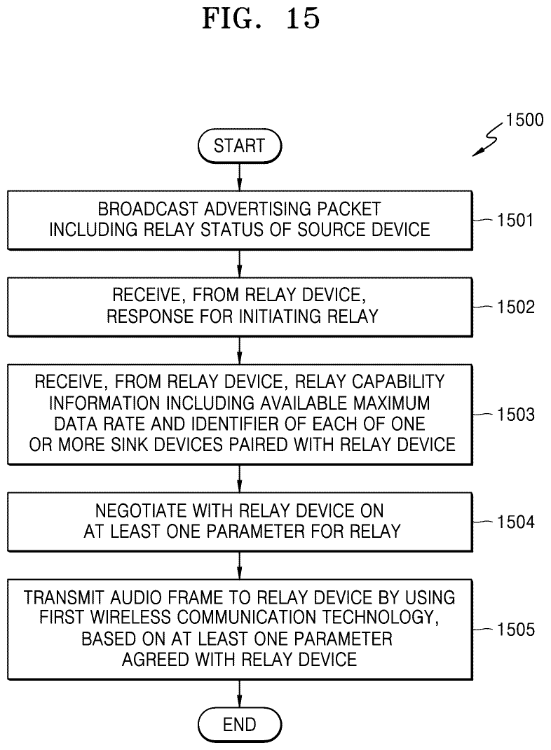

FIG. 15 illustrates an operating method 1500 of a source device according to an embodiment of the disclosure.

The operations of FIG. 15 may be performed by the source device 100 of FIG. 2.

In operation 1501, the source device 100 may broadcast an advertising packet including a relay status of the source device 100. Operation 1501 may correspond to operation 502 of FIG. 5.

In operation 1502, the source device 100 may receive, from the relay device 200, a response for initiating a relay. Operation 1502 may correspond to operation 512 of FIG. 5.

In operation 1503, the source device 100 may receive, from the relay device 200, relay capability information including an available maximum data rate and an identifier of each of one or more sink devices paired with the relay device 200. Operation 1503 may correspond to operation 516 of FIG. 5.

In operation 1504, the source device 100 may negotiate with the relay device 200 on at least one parameter for a relay. Operation 1504 may correspond to operations 520 to 524 of FIG. 5, operations 1008 to 1010 of FIG. 10, operations 1107 to 1109 of FIG. 11, operations 1209 to 1212 of FIGS. 12A and 12B, and operations 1307 to 1312 of FIGS. 13A and 13B.

In operation 1505, the source device 100 may transmit an audio frame to the relay device 200 based on the at least one parameter agreed with the relay device 200. Operation 1505 may correspond to operations 821 and 824 of FIG. 8.

According to an aspect of the disclosure, a method performed by an electronic device includes receiving an advertising packet including a relay status of a source device, transmitting, to the source device, a response for initiating a relay, based on a first user input for triggering a relay, transmitting, to the source device, relay capability information including an available maximum data rate and an identifier of each of one or more sink devices paired with the electronic device, negotiating with the source device on at least one parameter for a relay, receiving an audio frame from the source device by using a first wireless communication technology, based on the at least one parameter agreed with the source device, and transmitting the audio frame to a target sink device by using a second wireless communication technology, based on the at least one parameter agreed with the source device.

In an embodiment of the disclosure, the at least one parameter for a relay may include at least one of an identifier of a sink device, a data rate for transmission of the audio frame, or a time offset corresponding to a time at which the source device initiates transmission of the audio frame.

In an embodiment of the disclosure, the negotiating on the at least one parameter for a relay may include receiving, from the source device, a first parameter suggestion including a first identifier of a sink device, and transmitting, to the source device, a response for accepting the first parameter suggestion, based on the first identifier of the sink device being equal to one of the respective identifiers of the one or more sink devices paired with the electronic device.

In an embodiment of the disclosure, the method may further include receiving a second user input for designating the target sink device among the one or more sink devices paired with the electronic device, wherein the negotiating on the at least one parameter for a relay may include transmitting, to the source device, a response for rejecting the first parameter suggestion, based on the first identifier of the sink device being different from an identifier of the target sink device, receiving, from the source device, a second parameter suggestion including a second identifier of a sink device, and transmitting, to the source device, a response for accepting the second parameter suggestion, based on the second identifier of the sink device being equal to an identifier of the target sink device.

In an embodiment of the disclosure, the negotiating on the at least one parameter for a relay may include receiving, from the source device, a pairing request with the target sink device, pairing with the target sink device, transmitting, to the source device, a response indicating that the pairing with the target sink device is completed, receiving, from the source device, a third parameter suggestion including an identifier of the target sink device, and transmitting, to the source device, a response for accepting the third parameter suggestion.

In an embodiment of the disclosure, the receiving of the audio frame from the source device by using the first wireless communication technology may be performed at a time determined based on a time offset.

In an embodiment of the disclosure, the method may further include authenticating the source device based on an account logged in the source device and the electronic device.

In an embodiment of the disclosure, the method may further include checking a link condition of the first wireless communication technology with the source device, and checking a link condition of the second wireless communication technology with the one or more sink devices paired with the electronic device.

In an embodiment of the disclosure, the transmitting of the audio frame to the sink device may include segmenting the audio frame based on a size of a first data packet capable of being transmitted at once by using the first wireless communication technology and a size of a second data packet capable of being transmitted at once by using the second wireless communication technology, and transmitting the segmented audio frame to the sink device.

In an embodiment of the disclosure, the first wireless communication technology may include WiFi, and the second wireless communication technology may include Bluetooth.

According to an aspect of the disclosure, an electronic device includes a first communication module configured to transmit/receive signals to/from an external device by using a first wireless communication technology, a second communication module configured to transmit/receive signals to/from the external device by using a second wireless communication technology, memory storing one or more instructions, and at least one processor, wherein the one or more instructions, when executed by the at least one processor, cause the electronic device to receive an advertising packet including a relay status of a source device, transmit, to the source device, a response for initiating a relay, based on a first user input for triggering a relay, transmit, to the source device, relay capability information including an available maximum data rate and an identifier of each of one or more sink devices paired with the electronic device, negotiate with the source device on at least one parameter for a relay, receive an audio frame from the source device by using the first wireless communication technology, based on the at least one parameter agreed with the source device, and transmit the audio frame to a target sink device by using the second wireless communication technology, based on the at least one parameter agreed with the source device.

According to an aspect of the disclosure, a method performed by an electronic device includes broadcasting an advertising packet including a relay status of the electronic device, receiving, from a relay device, a response for initiating a relay, receiving, from the relay device, relay capability information including an available maximum data rate and an identifier of each of one or more sink devices paired with the relay device, negotiating with the relay device on at least one parameter for a relay, and transmitting an audio frame to the relay device by using a first wireless communication technology, based on the at least one parameter agreed with the relay device.

According to an aspect of the disclosure, an electronic device includes a first communication module configured to transmit/receive signals to/from an external device by using a first wireless communication technology, a second communication module configured to transmit/receive signals to/from the external device by using a third wireless communication technology, memory storing one or more instructions, and at least one processor, wherein the one or more instructions, when executed by the at least one processor, cause the electronic device to broadcast an advertising packet including a relay status of the electronic device, receive, from a relay device, a response for initiating a relay, receive, from the relay device, relay capability information including an available maximum data rate and an identifier of each of one or more sink devices paired with the relay device, negotiate with the relay device on at least one parameter for a relay, and transmit an audio frame to the relay device by using the first wireless communication technology, based on the at least one parameter agreed with the relay device.

Various embodiments of the disclosure may be implemented or supported by one or more computer programs, and the computer programs may be formed from computer-readable program code and may be included in a computer-readable medium. In the disclosure, the terms “application” and “program” may refer to one or more computer programs, software components, instruction sets, procedures, functions, objects, classes, instances, related data, or a portion thereof suitable for implementation in computer-readable program code. The “computer readable program code” may include various types of computer code including source code, object code, and executable code. The “computer-readable medium” may include various types of mediums accessible by a computer, such as read only memories (ROMs), random access memories (RAMs), hard disk drives (HDDs), compact discs (CDs), digital video discs (DVDs), or various types of memories.

Also, the machine-readable storage medium may be provided in the form of a non-transitory storage medium. The ‘non-transitory storage medium’ may be a tangible device and may exclude wired, wireless, optical, or other communication links for transmitting temporary electrical or other signals. Moreover, the ‘non-transitory storage medium’ may not distinguish between a case where data is semipermanently stored in the storage medium and a case where data is temporarily stored therein. For example, the “non-transitory storage medium” may include a buffer in which data is temporarily stored. The computer-readable medium may be any available medium accessible by a computer and may include volatile or non-volatile mediums and removable or non-removable mediums. The computer-readable medium may include a medium in which data may be permanently stored and a medium in which data may be stored and may be overwritten later, such as a rewritable optical disk or an erasable memory device.

According to an embodiment of the disclosure, the method according to various embodiments of the disclosure described herein may be included and provided in a computer program product. The computer program product may be traded as a product between a seller and a buyer. The computer program product may be distributed in the form of a machine-readable storage medium (e.g., a compact disc read only memory (CD-ROM)) or may be distributed (e.g., downloaded or uploaded) online through an application store or directly between two user devices. In the case of online distribution, at least a portion of the computer program product (e.g., a downloadable app) may be at least temporarily stored or temporarily generated in a machine-readable storage medium such as a manufacturer's server, a server of an application store, or a memory of a relay server.

The foregoing descriptions of the disclosure are merely examples, and those of ordinary skill in the art will readily understand that various modifications may be made therein without materially departing from the spirit or features of the disclosure. For example, suitable results may be achieved even when the described technologies are performed in a different order from the described method and/or the components of the described system, structure, apparatus, or circuit are coupled or combined in a different form from the described method or are replaced or substituted by other components or equivalents thereof. Therefore, it is to be understood that the embodiments described above should be considered in a descriptive sense only and not for purposes of limitation. For example, each component described as a single type may also be implemented in a distributed manner, and likewise, components described as being distributed may also be implemented in a combined form.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by an electronic device, the method comprising:
receiving, by the electronic device, an advertising packet comprising a relay status of a source device;
transmitting, by the electronic device to the source device, a response for initiating a relay, based on a first user input for triggering a relay;
transmitting, by the electronic device to the source device, relay capability information comprising an available maximum data rate and an identifier of each of one or more sink devices paired with the electronic device;
negotiating, by the electronic device, with the source device on at least one parameter for a relay;
receiving, by the electronic device, an audio frame from the source device by using a first wireless communication technology, based on the at least one parameter agreed with the source device; and
transmitting, by the electronic device, the audio frame to a target sink device by using a second wireless communication technology, based on the at least one parameter agreed with the source device.

2. The method of claim 1, wherein the at least one parameter for a relay comprises at least one of an identifier of a sink device, a data rate for transmission of the audio frame, or a time offset corresponding to a time at which the source device initiates transmission of the audio frame.

3. The method of claim 2, wherein the negotiating on the at least one parameter for a relay comprises:
receiving, from the source device, a first parameter suggestion including a first identifier of a sink device; and
transmitting, to the source device, a response for accepting the first parameter suggestion, based on the first identifier of the sink device being equal to one of the respective identifiers of the one or more sink devices paired with the electronic device.

4. The method of claim 3, further comprising:
receiving a second user input for designating the target sink device among the one or more sink devices paired with the electronic device,
wherein the negotiating on the at least one parameter for a relay comprises:
transmitting, to the source device, a response for rejecting the first parameter suggestion, based on the first identifier of the sink device being different from an identifier of the target sink device,
receiving, from the source device, a second parameter suggestion comprising a second identifier of a sink device, and
transmitting, to the source device, a response for accepting the second parameter suggestion, based on the second identifier of the sink device being equal to an identifier of the target sink device.

5. The method of claim 2, wherein the negotiating on the at least one parameter for a relay comprises:
receiving, from the source device, a pairing request with the target sink device;
pairing with the target sink device;
transmitting, to the source device, a response indicating that the pairing with the target sink device is completed;
receiving, from the source device, a third parameter suggestion comprising an identifier of the target sink device; and
transmitting, to the source device, a response for accepting the third parameter suggestion.

6. The method of claim 2, wherein the receiving of the audio frame from the source device by using the first wireless communication technology is performed at a time determined based on a time offset.

7. The method of claim 1, further comprising:
authenticating the source device based on an account logged in the source device and the electronic device.

8. The method of claim 1, further comprising:
checking a link condition of the first wireless communication technology with the source device; and
checking a link condition of the second wireless communication technology with the one or more sink devices paired with the electronic device.

9. The method of claim 2, wherein the transmitting of the audio frame to the sink device comprises:
segmenting the audio frame based on a size of a first data packet capable of being transmitted at once by using the first wireless communication technology and a size of a second data packet capable of being transmitted at once by using the second wireless communication technology; and
transmitting the segmented audio frame to the sink device.

10. The method of claim 1, wherein the first wireless communication technology comprises Wireless Fidelity (WiFi), and the second wireless communication technology comprises Bluetooth.

11. An electronic device comprising:
first communication circuitry configured to transmit/receive signals to/from an external device by using a first wireless communication technology;
second communication circuitry configured to transmit/receive signals to/from the external device by using a second wireless communication technology;
memory, comprising one or more storage media, storing one or more instructions; and
at least one processor communicatively coupled to the first communication circuitry, the second communication circuitry and the memory,
wherein the one or more instructions, when executed by the at least one processor individually or collectively, cause the electronic device to:
receive an advertising packet comprising a relay status of a source device,
transmit, to the source device, a response for initiating a relay, based on a first user input for triggering a relay,
transmit, to the source device, relay capability information comprising an available maximum data rate and an identifier of each of one or more sink devices paired with the electronic device,
negotiate with the source device on at least one parameter for a relay,
receive an audio frame from the source device by using the first wireless communication technology, based on the at least one parameter agreed with the source device, and
transmit the audio frame to a target sink device by using the second wireless communication technology, based on the at least one parameter agreed with the source device.

12. The electronic device of claim 11, wherein the at least one parameter for a relay comprises at least one of an identifier of a sink device, a data rate for transmission of the audio frame, or a time offset corresponding to a time at which the source device initiates transmission of the audio frame.

13. The electronic device of claim 12, wherein the negotiating on the at least one parameter for a relay comprises:
receiving, from the source device, a first parameter suggestion including a first identifier of a sink device; and
transmitting, to the source device, a response for accepting the first parameter suggestion, based on the first identifier of the sink device being equal to one of the respective identifiers of the one or more sink devices paired with the electronic device.

14. The electronic device of claim 13,
wherein the one or more instructions, when executed by the at least one processor individually or collectively, cause the electronic device to receive a second user input for designating the target sink device among the one or more sink devices paired with the electronic device, and
wherein the negotiating on the at least one parameter for a relay comprises:
transmitting, to the source device, a response for rejecting the first parameter suggestion, based on the first identifier of the sink device being different from an identifier of the target sink device,
receiving, from the source device, a second parameter suggestion comprising a second identifier of a sink device, and
transmitting, to the source device, a response for accepting the second parameter suggestion, based on the second identifier of the sink device being equal to an identifier of the target sink device.

15. The electronic device of claim 12, wherein the negotiating on the at least one parameter for a relay comprises:
receiving, from the source device, a pairing request with the target sink device;
pairing with the target sink device;
transmitting, to the source device, a response indicating that the pairing with the target sink device is completed;
receiving, from the source device, a third parameter suggestion comprising an identifier of the target sink device; and
transmitting, to the source device, a response for accepting the third parameter suggestion.

16. The electronic device of claim 12, wherein the receiving of the audio frame from the source device by using the first wireless communication technology is performed at a time determined based on a time offset.

17. The electronic device of claim 11, wherein the one or more instructions, when executed by the at least one processor individually or collectively, cause the electronic device to:
check a link condition of the first wireless communication technology with the source device; and
check a link condition of the second wireless communication technology with the one or more sink devices paired with the electronic device.

18. The electronic device of claim 12, wherein the transmitting of the audio frame to the sink device comprises:
segmenting the audio frame based on a size of a first data packet capable of being transmitted at once by using the first wireless communication technology and a size of a second data packet capable of being transmitted at once by using the second wireless communication technology; and
transmitting the segmented audio frame to the sink device.

19. The electronic device of claim 11, wherein the first wireless communication technology comprises Wireless Fidelity (WiFi), and the second wireless communication technology comprises Bluetooth.

20. A method performed by an electronic device, the method comprising:
broadcasting, by the electronic device, an advertising packet comprising a relay status of the electronic device;
receiving, by the electronic device from a relay device, a response for initiating a relay;
receiving, by the electronic device from the relay device, relay capability information comprising an available maximum data rate and an identifier of each of one or more sink devices paired with the relay device;
negotiating, by the electronic device, with the relay device on at least one parameter for a relay; and
transmitting, by the electronic device, an audio frame to the relay device by using a first wireless communication technology, based on the at least one parameter agreed with the relay device.
